(19) United States
(12) Patent Application Publication
(10) Pub. No.: US 2026/0011724 A1
(43) Pub. Date: Jan. 8, 2026

(54) Positive Electrode Active Material, Method for Preparing the Same, Positive Electrode Including the Same, and Lithium Secondary Battery

(71) Applicant: LG Energy Solution, Ltd., Seoul (KR)

(72) Inventors: Jin Tae Hwang, Daejeon (KR); Eun Sol Lho, Daejeon (KR); Su Yeon Oh, Daejeon (KR); Byung Chun Park, Daejeon (KR); Sang Min Park, Daejeon (KR); Sang Wook Lee, Daejeon (KR); Seul Ki Kim, Daejeon (KR); Hyeong II Kim, Daejeon (KR)

(73) Assignee: LG Energy Solution, Ltd., Seoul (KR)

(21) Appl. No.: 19/133,102

(22) PCT Filed: Dec. 1, 2023
(86) PCT No.: PCT/KR2023/019721

§ 371 Date: May 27, 2025

(30) Foreign Application Priority Data
Dec. 2, 2022 (KR) 10-2022-0166990
Dec. 2, 2022 (KR) 10-2022-0166991
Dec. 1, 2023 (KR) 10-2023-0172466

(51) Int. Cl. H01M 4/525; C01G 53/506; C01G 53/84; H01M 10/052

(52) U.S. Cl. CPC H01M 4/525; C01G 53/506; C01G 53/84; H01M 10/052; C01P 2002/50; C01P 2004/52; C01P 2004/61; C01P 2006/10; C01P 2006/11; C01P 2006/40

(57) ABSTRACT

The positive electrode active material includes a single particle composed of one single nodule, a quasi-single particle, which is a composite of at most 30 nodules, or a combination thereof. The positive electrode active material includes a lithium nickel-based oxide having a molar ratio of Ni of at least 60 mol % in the total transition metals, and a negative skewness factor (NSF) represented by Equation 1 below is 0.20 to 0.35:

$$NSF = ( {D}_{50} - {D}_{10} ) / {I}_{max} . \qquad [ Equation 1 ]$$

D₅₀ is a particle diameter at a cumulative volume of 50% in a volume cumulative particle size distribution graph of the positive electrode active material. D₁₀ is a particle diameter at a cumulative volume of 10% in a volume cumulative particle size distribution graph of the positive electrode active material. Iₘₐₓ is a maximum volume fraction in the volume cumulative particle size distribution graph of the positive electrode active material.

### CROSS-REFERENCE TO RELATED APPLICATIONS

The present application is a national phase entry under 35 U.S.C. § 371 of International Patent Application No. PCT/KR2023/019721, filed Dec. 1, 2023, which claims priority from Korean Patent Application Nos. 10-2022-0166990, filed on Dec. 2, 2022, 10-2022-0166991, filed on Dec. 2, 2022, and 10-2023-0172466, filed on Dec. 1, 2023, all of which are incorporated herein by reference.

### TECHNICAL FIELD

The present disclosure relates to a positive electrode active material, a method for preparing the same, a positive electrode including the same, and a lithium secondary battery.

### BACKGROUND

A lithium secondary battery generally includes a positive electrode, a negative electrode, a separator, and an electrolyte, and the positive electrode and the negative electrode include an active material capable of intercalation and deintercalation of lithium ions.

Lithium cobalt oxide (LiCoO₂), lithium nickel oxide (LiNiO₂), lithium manganese oxide (LiMnO₂, LiMnO₄, or the like), a lithium iron phosphate compound (LiFePO₄), or the like has been used as a positive electrode active material of the lithium secondary battery. Among these, the lithium cobalt oxide has the advantage of high operating voltage and excellent capacity characteristics, but it is difficult to commercially apply the lithium cobalt oxide to large-capacity batteries due to the high price and unstable supply of cobalt as a raw material. The lithium nickel oxide has poor structural stability, and thus it is difficult to achieve sufficient lifetime characteristics. Meanwhile, the lithium manganese oxide has excellent stability, but has a limitation of poor capacity characteristics. Accordingly, lithium composite transition metal oxides including two or more transition metals have been developed to compensate for limitations of lithium transition metal oxides including Ni, Co, or Mn alone, and among these, lithium nickel cobalt manganese oxides including Ni, Co, and Mn are widely used in electric vehicle batteries.

Conventional lithium metal oxides are generally in the form of spherical secondary particles in which tens to hundreds of primary particles are aggregated. However, when applying the lithium nickel cobalt manganese oxides in the form of secondary particles in which many primary particles are aggregated as described above, there is a limitation in that particle breakage, in which the primary particles fall off in a rolling process during the preparation of a positive electrode, is easy to occur and cracks occur in the particles during charge and discharge. When the particle breakage or cracks of the positive electrode active material occur, since a contact area with the electrolyte solution increases, gas generation and degradation of the active material due to a side reaction with the electrolyte solution are increased, and as a result, there is a limitation in that lifetime characteristics are deteriorated.

In order to solve the above limitations, a technique for preparing a positive electrode active material in the form of single particles rather than secondary particles by increasing a sintering temperature during the preparation of lithium nickel cobalt manganese oxides has been proposed. The positive electrode active material in the form of single particles has a smaller contact area with the electrolyte solution than that of a conventional positive electrode active material in the form of secondary particles, and thus has less side reactions with the electrolyte and excellent particle strength such that particle breakage is less during the manufacture of an electrode. Therefore, when the positive electrode active material in the form of single particles is applied, there is an advantage that gas generation and lifetime characteristics are excellent. However, there is a limitation in that the conventional positive electrode active material in the form of single particle has a high resistance, and thus when this is applied, sufficient output performance cannot be obtained.

Meanwhile, the tap density and the pellet density can be increased only by an increase in the average particle diameter of the positive electrode active material in the form of a single particle, but when the average particle diameter is increased above a certain level, there are limitations in that the diffusion distance of lithium ions in the particles increases and the initial resistance increases.

Therefore, there is a need for a technique capable of increasing the pellet density while reducing the average particle diameter of the positive electrode active material in the form of a single particle as small as possible.

### SUMMARY

### Technical Problem

An aspect of the present disclosure provides a positive electrode active material having low initial resistance characteristics and high energy density due to a specific particle size distribution, a method for preparing the same, a positive electrode including the same, and a lithium secondary battery.

### Technical Solution

According to an aspect of the present disclosure, there is provided a positive electrode active material including a single particle composed of one single nodule, a quasi-single particle, which is a composite of at most 30 nodules, or a combination thereof, wherein the positive electrode active material includes a lithium nickel-based oxide having a molar ratio of Ni of at least 60 mol % in the total transition metals, and a negative skewness factor (NSF) represented by Equation 1 below is 0.20 to 0.35:

$$NSF = ( {D}_{50} - {D}_{10} ) / {I}_{max} \qquad [ Equation 1 ]$$

In Equation 1 above, D₅₀ is a particle diameter at a cumulative volume of 50% in a volume cumulative particle size distribution graph of the positive electrode active material, D₁₀ is a particle diameter at a cumulative volume of 10% in a volume cumulative particle size distribution graph of the positive electrode active material, and Iₘₐₓ is a maximum volume fraction in the volume cumulative particle size distribution graph of the positive electrode active material.

The positive electrode active material may have a D₅₀ of 5.0 μm to 7.0 μm.

The lithium nickel-based oxide may be represented by Formula 1 below:

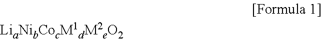

In Formula 1 above, M¹ is Mn, Al, or a combination thereof, M² is at least one selected from the group consisting of Ba, Ca, Zr, Ti, Mg, Ta, Nb, and Mo, 1.0≤a≤1.5, 0.6≤b<1.0, 0<c<0.1, 0<d<0.2, 0≤e≤0.1, and 0<c+d+e≤0.4.

The positive electrode active material may have an average particle diameter of nodules of 1.0 μm to 7.0 μm.

The positive electrode active material may have a tap density of 2.40 g/cc to 2.60 g/cc.

The positive electrode active material may have a pellet density (at 9 ton) of 3.60 g/cc to 3.80 g/cc.

An initial resistance of the monocell manufactured using the positive electrode active material at an SOC of 50 may be 1.45 Ω to 1.50 Ω.

According to another aspect of the present disclosure, there is provided a method for preparing a positive electrode active material, the method including: mixing a positive electrode active material precursor and a lithium raw material and performing primary firing; and pulverizing the primary fired product and performing secondary firing.

The positive electrode active material precursor may have D₅₀ of 4.0 μm to 10.0 μm.

The pulverizing may be performed by jet-mill pulverization.

The jet-mill pulverization may be performed under the conditions of 2.0 bar to 4.0 bar and 1,000 rpm to 2,500 rpm.

According to another aspect of the present disclosure, there are provided a positive electrode including the above-described positive electrode active material, and a lithium secondary battery including the positive electrode.

### Advantageous Effects

The positive electrode active material according to the present disclosure has NSF satisfying a specific range, so that small particles fill spaces between relatively large particles and a tap density and a pellet density increase, thereby enabling a lithium secondary battery including the positive electrode active material to achieve a high energy density.

In addition, the positive electrode active material according to the present disclosure has the NSF satisfying a specific range, thereby reducing the diffusion distance of lithium ions in the particle, and thus the lithium secondary battery including the positive electrode active material may achieve a low initial resistance.

### DESCRIPTION OF THE DRAWINGS

FIG. 1 includes graphs showing volume cumulative particle size distribution of positive electrode active materials prepared according to Examples 1 to 4 of the present disclosure and Comparative Examples 1 to 4.

FIG. 2 is a graph showing tap densities depending on D₅₀ of the positive electrode active materials prepared according to Examples 1 to 4 of the present disclosure and Comparative Examples 1 to 4.

FIG. 3 is a graph showing pellet densities depending on D₅₀ of the positive electrode active materials prepared according to Examples 1 to 4 of the present disclosure and Comparative Examples 1 to 4.

FIG. 4 is a graph showing pellet densities depending on NSF values of the positive electrode active materials prepared according to Examples 1 to 4 of the present disclosure and Comparative Examples 1 to 4.

FIG. 5 is a graph showing initial resistances depending on D50 of a lithium secondary battery including the positive electrode active materials prepared according to Examples 1 to 4 of the present disclosure and Comparative Examples 1 to 4.

### DETAILED DESCRIPTION

It will be understood that terms or words used in the present specification and claims shall not be construed as being limited to having meanings defined in commonly used dictionaries, but should be interpreted as having meanings and concepts consistent with the technical idea of the present invention based on the e principle that an inventor may appropriately define concepts of the terms to best explain the invention.

As used herein, the term “single particle” refers to a particle composed of a single nodule. As used herein, the term “quasi-single particle” refers to a particle that is a composite particle formed of at most 30 nodules.

As used herein, the term “nodule” refers to a particle unit body constituting single particles and quasi-single particles, and the nodule may be a single crystal which lacks a crystalline grain boundary, or may be a polycrystal having no grain boundary in appearance when observed in the view at a magnification of 5,000 to 20,000 using a scanning electron microscope (SEM). The average particle diameter of the nodules may be determined with an arithmetic mean value of the particle diameters of each nodule measured using a scanning electron microscope (SEM).

As used herein, the term “secondary particle” refers to a particle formed by aggregation of tens to hundreds of primary particles. More specifically, the secondary particle is an aggregate of at least 40 primary particles.

The expression “particle” used herein may include any one or all among a single particle, a quasi-single particle, a primary particle, a nodule, and a secondary particle.

As used herein, the term “D₅₀” refers to a particle size based on 50% of the volume cumulative particle size distribution of the positive electrode active material. The D₅₀ may be measured using a laser diffraction method. For example, powder of positive electrode active materials may be dispersed in a dispersion medium, then introduced into a commercially available laser diffraction particle size measuring apparatus (e.g., Microtrac MT 3000), irradiated with an ultrasonic wave of about 28 kHz at a 60-W output. Then, after a volume cumulative particle size distribution graph may be obtained, a particle size corresponding to 50% of the volume cumulative amount may be determined to measure the average particle diameter D₅₀.

Hereinafter, the present invention will be described in more detail.

### Positive Electrode Active Material

The positive electrode active material according to the present disclosure includes a single particle composed of one single nodule, a quasi-single particle which is a composite of at most 30 nodules, or a combination thereof.

Since the lithium nickel-based oxides in the form of single particles and/or quasi-single particles have higher particle strength than the conventional lithium nickel-based oxide in the form of secondary particles in which tens to hundreds of primary particles are aggregated, there is less particle breakage during rolling.

In addition, the lithium nickel-based oxide in a single-particle or quasi-single-particle form according to the present disclosure has less number of sub-components (i.e., nodules) constituting the particles, thereby reducing changes due to volume expansion and contraction o of the primary particles during charging discharging, and thus and significantly reducing cracks within the particles.

In particular, it has been found that when a positive electrode active material having a negative skewness factor (NSF) satisfying a certain range, the NSF being represented by Equation 1 below is applied, particle breakage may be minimized in the electrode manufacturing process to reduce gas generation, a change in crystal structure may be minimized during the charging and discharging, a diffusion distance of lithium ions in the particles may be reduced to achieve low initial resistance characteristics, and the energy density may be improved by maximizing a tap density and a pellet density.

$$NSF = ( {D}_{50} - {D}_{10} ) / {I}_{max} \qquad [ Equation 1 ]$$

In Equation 1 above, D₅₀ is a particle diameter at a cumulative volume of 50% in a volume cumulative particle size distribution graph of the positive electrode active material, D₁₀ is a particle diameter at a cumulative volume of 10% in a volume cumulative particle size distribution graph of the positive electrode active material, and Iₘₐₓ is a maximum volume fraction in the volume cumulative particle size distribution graph of the positive electrode active material.

The positive electrode active material according to the present disclosure may include a lithium nickel-based oxide having a molar ratio of Ni of at least 60 mol %, at least 70 mol %, or at least 80 mol % in the total transition metals.

The positive electrode active material according to the present disclosure may have an NSF value of 0.20 to 0.35, 0.21 to 0.35, or 0.21 to 0.34. According to the study of the present inventors, when the NSF value is less than 0.20 or greater than 0.35, the tap density and pellet density are found to decrease.

When the NSF value satisfies the above range, the tap density and pellet density increase as the small particles fill the spaces between the relatively large particles. When the NSF value is less than 0.20, there are insufficient small particles to fill the spaces between the large particles, and when the NSF value is greater than 0.35, the small particles remain after the small particles fill the spaces between the large particles, resulting in a reduction in the pellet density. Accordingly, even if D₅₀ is at the same level, the tap density and pellet density may be maximized when the NSF value is optimized.

The positive electrode active material according to the present disclosure may have D₅₀ of 5.0 μm to 7.0 μm, 5.5 μm to 6.5 μm, or 5.6 μm to 6.2 μm. When the D₅₀ of the positive electrode active material according to the present disclosure satisfies the above range, the low initial resistance characteristics and high energy density may be achieved. When the NSF value is the same, the pellet density increases as the D₅₀ of the positive electrode active material increases. When the D₅₀ of the positive electrode active material is less than 5.0 μm, it may be difficult to achieve a relatively high pellet density even though an optimal level of NSF is achieved, and when the D₅₀ is greater than 7.0 μm, the lithium mobility of the positive electrode active material decreases and thus the initial resistance of the lithium secondary battery including the positive electrode active material may increase.

Meanwhile, the positive electrode active material according to the present disclosure may include a lithium nickel-based oxide, and specifically, may include a lithium nickel-based oxide having a composition as shown in Formula 1 below.

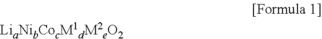

In Formula 1 above, M¹ is Mn, Al, or a combination thereof, and preferably, Mn or a combination of Mn and Al, and M² is at least one selected from the group consisting of Ba, Ca, Zr, Ti, Mg, Ta, Nb, and Mo. The M² element is not necessarily included, but when included in an appropriate amount, the M² element may serve to promote particle growth during the sintering or improve the crystal structure stability.

a above denotes a molar ratio of lithium in the lithium nickel-based oxide, and may satisfy 1.0≤a≤1.5, 1.1≤a≤1.4, or 1.2≤a≤1.3. When the molar ratio of lithium satisfies the above range, the stable layered crystal structure may be formed.

b above denotes a molar ratio of nickel among all metals excluding lithium in the lithium nickel-based oxide, and may satisfy 0.6≤b<1.0, 0.8≤b<1.0, or 0.82≤b<1.0. When the molar ratio of nickel satisfies the above range, the capacity characteristics are excellent, and particularly, when the molar ratio of nickel is 0.8 or more, better capacity characteristics may be achieved.

c above denotes a molar ratio of cobalt among all metals excluding lithium in the lithium nickel-based oxide, and may satisfy 0<c<0.1, 0<c<0.08, or 0<c<0.06.

d above denotes a molar ratio of the M¹ among all metals excluding lithium in the lithium nickel-based oxide, and may satisfy 0<d<0.2, 0<d<0.18, or 0<d<0.15.

e above denotes a molar ratio of the M² element among all metals excluding lithium in the lithium nickel-based oxide, and may satisfy 0≤e≤0.1, 0≤e≤0.08, or 0≤e≤0.06.

The positive electrode active material according to the present disclosure may have an average particle diameter of nodules of 1.0 μm to 7.0 μm, 2.0 μm to 6.0 μm, or 3.0 μm to 5.0 μm. When the average particle diameter of the nodules of the positive electrode active material according to the present disclosure satisfies the above range, high energy density and low initial resistance characteristics may be achieved. When the average particle diameter of the nodules of the positive electrode active material according to the present disclosure is less than 1.0 μm, the total specific surface area of the positive electrode active material is increased so that the side reaction of the electrolyte solution may be increased, and when the average particle diameter of the nodules is greater than 7.0 μm, the lithium mobility of the positive electrode active material is decreased, and thus the output characteristics of the battery may be deteriorated.

The positive electrode active material according to the present disclosure may have a tap density of 2.40 g/cc to 2.60 g/cc, 2.42 g/cc to 2.56 g/cc, or 2.43 g/cc to 2.54 g/cc. When the tap density of the positive electrode active material according to the present disclosure satisfies the above range, a high energy density may be achieved.

The positive electrode active material according to the present disclosure may have a pellet density (at 9 ton) of 3.60 g/cc to 3.80 g/cc, 3.61 g/cc to 3.78 g/cc, or 3.62 g/cc to 3.75 g/cc. When the pellet density of the positive electrode active material according to the present disclosure satisfies the above range, a high energy density may be achieved.

Meanwhile, an initial resistance of the monocell manufactured using the positive electrode active material at an SOC of 50 may be 1.45 Ω to 1.50 Ω, preferably 1.47 Ω to 1.50 Ω, and more preferably 1.48 Ω to 1.49 Ω.

### Method for Preparing Positive Electrode Active Material

Next, a method for preparing a positive electrode active material of the present disclosure will be described.

A method for preparing a positive electrode active material according to the present disclosure includes the steps of: (A) mixing a positive electrode active material precursor and a lithium raw material and performing primary firing; and (B) pulverizing the primary fired product and performing secondary firing.

In addition, the prepared positive electrode active material includes a single particle composed of one single nodule, a quasi-single particle, which is a composite of at most 30 nodules, or a combination thereof, wherein the positive electrode active material includes a lithium nickel-based oxide having a molar ratio of Ni of at least 60 mol % in the total transition metals, and a negative skewness factor (NSF) represented by Equation 1 below is 0.20 to 0.35:

$$NSF = ( {D}_{50} - {D}_{10} ) / {I}_{max} \qquad [ Equation 1 ]$$

In Equation 1 above, D₅₀ is a particle diameter at a cumulative volume of 50% in a volume cumulative particle size distribution graph of the positive electrode active material, D₁₀ is a particle diameter at a cumulative volume of 10% in a volume cumulative particle size distribution graph of the positive electrode active material, and Iₘₐₓ is a maximum volume fraction in the volume cumulative particle size distribution graph of the positive electrode active material.

The same description above is applied to Equation 1 above, and duplicated description will be omitted.

Hereinafter, each step of the method for preparing a positive electrode active material will be described in detail.

First, a positive electrode active material precursor and a lithium raw material are mixed and then first fired (step (A)).

In this case, the positive electrode active material precursor may be prepared by purchasing a precursor such as a commercially available nickel cobalt manganese-based hydroxide or the like, or by a precursor preparation method known in the art such as a co-precipitation method.

For example, a transition metal-containing solution containing cations of nickel (Ni), cobalt (Co), and M¹ may be prepared, and then an ammonium cation-containing complexing agent and a basic aqueous solution may be added to the transition metal-containing solution to perform co-precipitation reaction, thereby preparing a positive electrode active material precursor.

The transition metal-containing solution may contain a nickel-containing raw material, a cobalt-containing raw material, and an M¹-containing raw material, and the M¹-containing raw material may be a manganese-containing raw material and/or an aluminum-containing raw material.

The nickel-containing raw material may include, for example, nickel-containing acetates, nitrates, sulfates, halides, sulfides, hydroxides, oxides, or oxyhydroxides, and may specifically include Ni(OH)₂, NiO, NiOOH, NiCO₃·2Ni(OH)₂·4H₂O, NiC₂O₂·2H₂O, Ni(NO₃)₂·6H₂O, NiSO₄, NiSO₄·6H₂O, a fatty acid nickel salt, a nickel halide, or a combination thereof, but the present disclosure is not limited thereto.

The cobalt-containing raw material may include cobalt-containing acetates, nitrates, sulfates, halides, sulfides, hydroxides, oxides, or oxyhydroxides, and may specifically include Co(OH)₂, CoOOH, Co(OCOCH₃)₂·4H₂O, Co(NO₃)₂·6H₂O, CoSO₄, Co(SO₄)₂·7H₂O, or a combination thereof, but the present disclosure is not limited thereto.

The manganese-containing raw material may include, for example, manganese-containing acetates, nitrates, sulfates, halides, sulfides, hydroxides, oxides, oxyhydroxides, or a combination thereof, and may specifically include a manganese oxide such as Mn₂O₃, MnO₂, and Mn₃O₄; a manganese salt such as MnCO₃, Mn(NO₃)₂, MnSO₄, manganese acetate, manganese dicarboxylate, manganese citrate, and a fatty acid manganese salt; a manganese manganese chloride, or a combination thereof, but the present disclosure is not limited thereto.

The aluminum-containing raw material may be, for example, Al₂O₃, Al(OH)₃, Al(NO₃)₃, Al₂(SO₄)₃, (HO)₂A1CH₃CO₂, HOAl (CH₃CO₂)₂, Al(CH₃CO₂)₃, an aluminum halide, or a combination thereof.

The transition metal-containing solution may be prepared by adding the nickel-containing raw material, the cobalt-containing raw material, and the M¹-containing raw material to a solvent, specifically water, or a mixed solvent of an organic solvent (e.g., alcohol, etc.) which may be uniformly mixed with the water, or may be prepared by mixing an aqueous solution of the nickel-containing raw material, an aqueous solution of the cobalt-containing raw material, and the M¹-containing raw material.

The ammonium cation-containing complexing agent may include, for example, NH₄OH, (NH₄)₂SO₄, NH₄NO₃, NH₄Cl, CH₃COONH₄, NH₄CO₃, or a combination thereof, but the present disclosure is not limited thereto. Meanwhile, the ammonium cation-containing complexing agent may be used in the form of an aqueous solution, and, in this case, water or a mixture of water and an organic solvent (specifically, alcohol etc.), which may be uniformly mixed with the water, may be used as a solvent.

The basic compound may include a hydroxide of alkali metal or alkaline earth metal, such as NaOH, KOH, or Ca(OH)₂, a hydrate thereof, or a combination thereof. The basic compound may also be used in the form of an aqueous solution, and, in this case, water or a mixture of water and an organic solvent (specifically, alcohol etc.), which may be uniformly mixed with the water, may be used as a solvent.

The basic compound is added to adjust a pH of a reaction solution, wherein the basic compound may be added in an amount such that the pH of the metal solution is 8 to 12.

The co-precipitation reaction may be performed in a temperature range of 35° C. to 80° C. in an inert atmosphere such as nitrogen or argon.

The positive electrode active material precursor particles of a nickel-cobalt-M¹ hydroxide are formed by the above-described process, and are precipitated in the reaction solution. A positive electrode active material precursor having a nickel (Ni) content of at least 60 mol % in the total metal content may be prepared by controlling concentrations of a nickel-containing raw material, a cobalt-containing raw material, and an M¹-containing raw material. The precipitated positive electrode active material precursor particles may be separated according to a conventional method and dried to prepare a positive electrode active material precursor.

Meanwhile, the positive electrode active material precursor as prepared above may have a D₅₀ of 4.0 μm to 10.0 μm, preferably 5.0 μm to 9.0 μm, and more preferably 6.0 μm to 8.0 μm. When the D₅₀ of the positive electrode active material precursor is less than 4.0 μm, the possibility that the D₅₀ of the positive electrode active material is smaller than the appropriate range increases, and when the D₅₀ of the positive electrode active material precursor is greater than 10.0 μm, the specific surface area (BET) decreases, and thus reactivity when mixed with the lithium raw material decreases, thereby reducing the degree of completion of the structure of the positive electrode active material.

Thereafter, the positive electrode active material precursor and the lithium raw material may be mixed.

As the lithium raw material, lithium-containing sulfates, nitrates, acetates, carbonates, oxalates, citrates, halides, hydroxides, or oxyhydroxides may be used, and these materials are not particularly limited as long as they may be dissolved in water. Specifically, the lithium raw material may include Li₂CO₃, LiNO₃, LiNO₂, LiOH, LiOH·H₂O, LiH, LiF, LiCl, LiBr, LiI, CH₃COOLi, Li₂O, Li₂SO4, CH₃COOLi, Li₃C₆H₅O₇, or the like, and any one thereof or a mixture of two or more thereof may be used.

The positive active material precursor and the lithium raw material may be mixed in a molar ratio of, for example, about 1:1, about 1:1.05, about 1:1.10, about 1:1.15, or about 1:1.20, but the present disclosure is not limited thereto.

Thereafter, the mixture may be primarily fired.

The primary firing may be conducted in an air or oxygen atmosphere.

The primary firing may be performed at a temperature of 700° C. to 1,000° C., 800° C. to 900° C., or 825° C. to 875° C. The primary firing may be performed for 6 hours to 18 hours, 8 hours to 16 hours, or 10 hours to 14 hours.

Next, the primary fired product is pulverized and secondarily fired (step (B)).

In this case, the pulverizing may be performed by, for example, jet-mill pulverization. The jet-mill pulverization may be performed in a pressure range of 2.0 bar to 4.0 bar, 2.2 bar to 3.8 bar, or 2.4 bar to 3.5 bar.

In addition, the jet-mill pulverization may be performed at a speed range of 1,000 rpm to 2,500 rpm, 1,200 rpm to 2,400 rpm, or 1,300 rpm to 2,300 rpm. The positive electrode active material prepared by performing in the pulverization speed range may have an NSF value of 0.20 to 0.35, 0.21 to 0.35, or 0.21 to 0.34. Accordingly, the prepared positive electrode active material may achieve the low initial resistance characteristics and high energy density.

Through the jet-mill pulverization, the degree of completion of the structure of the surface exposed by particle breakage may be increased.

The secondary firing may be performed at a temperature of 500° C. to 1,000° C., 600° C. to 900° C., or 700° C. to 800° C.

The secondary firing may be performed for 6 hours to 18 hours, 8 hours to 16 hours, or 10 hours to 14 hours.

Through the recrystallization reaction generated through the secondary firing, the degree of completion of the structure of positive electrode active material may be increased compared to the positive electrode active material after the primary firing.

After the jet-mill pulverization, the secondary firing may be performed to recrystallize the surface exposed by the particle breakage and remove the fine powder in the process of recrystallizing.

Meanwhile, in the case of preparing an M² metal-containing lithium composite transition metal oxide, M² metal-containing raw materials may be additionally mixed during the co-precipitation reaction or in the firing step. In this case, the M² metal-containing raw material may be an acetate, carbonate, nitrate, sulfate, halide, sulfide, or oxide of the M² metal.

### Positive Electrode

The positive electrode according to the present disclosure includes the positive electrode active material of the present disclosure as described above. Specifically, the positive electrode includes a positive electrode current collector and a positive electrode active material layer formed on the positive electrode current collector, and the positive electrode active material layer includes the positive electrode active material according to the present disclosure. Since the positive electrode active material is described above, detailed descriptions thereof will be omitted, and the remaining configurations will be only described in detail below.

The positive electrode current collector may include a metal having high conductivity, and is not particularly limited as long as the positive electrode active material layer easily adheres thereto and there is no reactivity in the voltage range of the battery. For example, stainless steel, aluminum, nickel, titanium, heat-treated carbon, or aluminum or stainless steel that is surface-treated with one of carbon, nickel, titanium, silver, or the like may be used as the positive electrode current collector. Also, the positive electrode current collector may typically have a thickness of 3 μm to 500 μm, and microscopic irregularities may be formed on the surface of the current collector to improve the adhesion of the positive electrode active material. The positive electrode current collector, for example, may be used in various shapes such as a film, a sheet, a foil, a net, a porous body, a foam body, and a non-woven fabric body.

The positive electrode active material layer may optionally include a conductive agent and a binder together with the positive electrode active material as necessary.

In this case, the positive electrode active material may be included in a content of 80 wt % to 99 wt %, more specifically, 90 wt % to 98 wt % with respect to the total weight of the positive electrode active material layer.

The conductive agent is used to provide conductivity to the electrode, wherein any conductive agent may be used without particular limitation as long as it has suitable electron conductivity without causing adverse chemical changes in the battery. Specific examples of the conductive agent may be graphite such as natural graphite or artificial graphite; carbon based materials such as carbon black, acetylene black, Ketjen black, channel black, furnace black, lamp black, thermal black, and carbon fibers; powder or fibers of metals such as copper, nickel, aluminum, and silver; conductive tubes such as carbon nanotubes; conductive whiskers such as zinc oxide whiskers and potassium titanate whiskers; conductive metal oxides such as titanium oxide; or conductive polymers such as polyphenylene derivatives, and any one thereof or a mixture of two or more thereof may be used. The conductive agent may be included in an amount of 0.01 wt % to 10 wt %, preferably 0.1 wt % to 9 wt %, and more preferably 0.1 wt % to 5 wt % with respect to the total weight of the positive electrode active material layer.

The binder serves to improve binding between positive electrode active material particles and the adhesion between the positive electrode active material and the current collector. Specific examples of the binder may be polyvinylidene fluoride (PVDF), polyvinylidene fluoride-hexafluoropropylene copolymer (PVDF-Co-HFP), polyvinyl alcohol, polyacrylonitrile, polymethylmethacrylate, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene polymer (EPDM), a sulfonated EPDM, a styrene-butadiene rubber (SBR), a fluorine rubber, poly acrylic acid, and a polymer having hydrogen thereof substituted with Li, Na, or Ca, or various copolymers thereof, and any one thereof or a mixture of two or more thereof may be used. The binder may be included in an amount of 1 wt % to 30 wt %, preferably 1 wt % to 20 wt %, and more preferably 1 wt % to 10 wt % with respect to the total weight of the positive electrode active material layer.

The positive electrode may be prepared according to a typical method for preparing a positive electrode except that the above-described positive electrode active material is used. Specifically, a positive electrode slurry composition, which is prepared by dissolving or dispersing optionally the binder, the conductive agent, and the dispersing agent, if necessary, as well as the positive electrode active material in a solvent, is coated on the positive electrode collector, and the positive electrode may then be prepared by drying and rolling the coated positive electrode collector.

The solvent may be a solvent normally used in the art. The solvent may include dimethyl sulfoxide (DMSO), isopropyl alcohol, N-methylpyrrolidone (NMP), dimethyl formamide (DMF), acetone, or water, and any one thereof or a mixture of two or more thereof may be used. An amount of the solvent used may be sufficient if the solvent may dissolve or disperse the positive electrode active material, the conductive agent, the binder, and the dispersing agent in consideration of a coating thickness of the slurry and manufacturing yield, and may allow to have a viscosity that may provide excellent thickness uniformity during the subsequent coating for the preparation of the positive electrode.

Also, as another method, the positive electrode may be prepared by casting the positive electrode slurry composition on a separate support and then laminating a film separated from the support on the positive electrode collector.

### Lithium Secondary Battery

Next, a lithium secondary battery according to the present disclosure will be described.

The lithium secondary battery specifically includes a positive electrode, a negative electrode disposed to face the positive electrode, a separator disposed between the positive electrode and the negative electrode, and an electrolyte, wherein, since the positive electrode is the same as described above, detailed descriptions thereof will be omitted, and the remaining configurations will be only described in detail below.

Also, the lithium secondary battery may further optionally include a battery container which accommodates an electrode assembly of the positive electrode, the negative electrode, and the separator, and a sealing member which seals the battery container.

In the lithium secondary battery, the negative electrode includes a negative electrode collector and a negative electrode active material layer disposed on the negative electrode collector.

The negative electrode current collector is not particularly limited as long as it has high conductivity without causing adverse chemical changes in the battery, and, for example, copper, stainless steel, aluminum, nickel, titanium, heat-treated carbon, copper or stainless steel that is surface-treated with one of carbon, nickel, titanium, silver, or the like, and an aluminum-cadmium alloy may be used. Also, the negative electrode current collector may typically have a thickness of 3 μm to 500 μm, and as in the case of the positive electrode current collector, microscopic irregularities may be formed on the surface of the negative electrode current collector to enhance the adhesion of a negative electrode active material. For example, the negative electrode current collector may be used in various shapes such as a film, a sheet, a foil, a net, a porous body, a foam body, and a non-woven fabric body.

The negative electrode active material layer optionally includes a binder and a conductive agent in addition to the negative electrode active material.

A compound capable of reversibly intercalating and deintercalating lithium may be used as the negative electrode active material. Specific examples of the negative electrode active material may be a carbonaceous material such as artificial graphite, natural graphitized carbon fibers, and amorphous carbon; a metallic compound alloyable with lithium such as Si, Al, Sn, Pb, Zn, Bi, In, Mg, Ga, Cd, a Si alloy, a Sn alloy, or an Al alloy; a metal oxide which may be doped and undoped with lithium such as SiOβ (0<β<2), SnO₂, vanadium oxide, and lithium vanadium oxide; or a composite including the metallic compound and the carbonaceous material such as a Si—C composite or a Sn—C composite, and any one thereof or a mixture of two or more thereof may be used. Also, a metallic lithium thin film may be used as the negative electrode active material. Furthermore, both low crystalline carbon and high crystalline carbon may be used as the carbon material. Typical examples of the low crystalline carbon may be soft carbon and hard carbon, and typical examples of the high crystalline carbon may be irregular, planar, flaky, spherical, or fibrous natural graphite or artificial graphite, Kish graphite, pyrolytic carbon, mesophase pitch-based carbon fibers, meso-carbon microbeads, mesophase pitches, and high-temperature heat-treated carbon such as petroleum or coal tar pitch derived cokes.

The negative electrode active material may be included in an amount of 80 wt % to 99 wt %, 82 wt % to 99 wt %, or 84 wt % to 99 wt % with respect to the total weight of the negative electrode active material layer.

The binder is a component that assists in the binding between the conductive agent, the active material, and the current collector, wherein the binder is commonly added in an amount of 0.1 wt % to 10 wt % based on the total weight of the negative electrode active material layer. Examples of the binder may include a polyvinylidene fluoride (PVDF), a polyvinyl alcohol, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene polymer (EPDM), a sulfonated EPDM, a styrene-butadiene rubber, a nitrile-butadiene rubber, a fluoro rubber, various copolymers thereof, and the like.

The conductive agent is a component for further improving the conductivity of the negative electrode active material, and may be included in an amount of 1 wt % to 30 wt %, 1 wt % to 20 wt %, or 1 wt % to 10 wt % with respect to the total weight of the negative electrode active material layer. The conductive agent is not particularly limited as long as it has conductivity without causing adverse chemical changes in the battery. For example, graphite such as natural graphite or artificial graphite; carbon black such as acetylene black, Ketjen black, channel black, furnace black, lamp black, and thermal black; conductive fibers such as carbon fibers or metal fibers; fluorocarbons; metal powder such as aluminum powder or nickel powder; a conductive whisker such as a zinc oxide whisker or a potassium titanate whisker; a conductive metal oxide such as a titanium oxide; or a conductive material such as a polyphenylene derivative; and the like may be used.

The negative electrode active material layer may be prepared by coating a negative electrode slurry composition, which is prepared by dissolving or dispersing optionally the binder and the conductive agent as well as the negative electrode active material in a solvent, on the negative electrode current collector and drying the coated negative electrode current collector, or may be prepared by casting the negative electrode slurry composition on a separate support and then laminating a film separated from the support on the negative electrode current collector.

Meanwhile, in the lithium secondary battery, the separator separates the negative electrode and the positive electrode and provides a movement path of lithium ions, and any separator may be used as the separator without particular limitation as long as it is typically used as a separator in a lithium secondary battery, and particularly, a separator having high moisture-retention ability for an electrolyte as well as low resistance to the transfer of electrolyte ions may be prepared. Specifically, a porous polymer film, for example, a porous polymer film prepared from a polyolefin-based polymer, such as an ethylene homopolymer, a propylene homopolymer, an ethylene/butene copolymer, an ethylene/hexene copolymer, and an ethylene/methacrylate copolymer, or a laminated structure having two or more layers thereof may be used. Also, a typical porous non-woven fabric, for example, a non-woven fabric formed of high melting glass point fibers or polyethylene terephthalate fibers may be used. Furthermore, a coated separator including a ceramic component or a polymer material may be used in order to secure heat resistance or mechanical strength, and the separator having a single layer or multilayer structure may be optionally used.

Also, the electrolyte used in the present disclosure may include an organic liquid electrolyte, an inorganic liquid electrolyte, a solid polymer electrolyte, a gel-type polymer electrolyte, a solid inorganic electrolyte, or a molten-type inorganic electrolyte which may be used in the preparation of the lithium secondary battery, but the present disclosure is not limited thereto.

Specifically, the electrolyte may include an organic solvent and a lithium salt.

Any organic solvent may be used as the organic solvent without particular limitation so long as it may function as a medium through which ions involved in an electrochemical reaction of the battery may move. Specifically, an ester-based solvent such as methyl acetate, ethyl acetate, Υ-butyrolactone, and ϵ-caprolactone; an ether-based solvent such as dibutyl ether or tetrahydrofuran; a ketone-based solvent such as cyclohexanone; an aromatic hydrocarbon-based solvent such as benzene and fluorobenzene; or a carbonate-based solvent such as dimethyl carbonate (DMC), diethyl carbonate (DEC), methylethyl carbonate (MEC), ethylmethyl carbonate (EMC), ethylene carbonate (EC), and propylene carbonate (PC); an alcohol-based solvent such as ethyl alcohol and isopropyl alcohol; nitriles such as R-CN (where R is a linear, branched, or cyclic C2-C20 hydrocarbon group and may include a double-bond aromatic ring or ether bond); amides such as dimethylformamide; dioxolanes such as 1,3-dioxolane; or sulfolanes may be used as the organic solvent. Among these solvents, the carbonate-based solvent may be used, and, for example, a mixture of a cyclic carbonate (e.g., ethylene carbonate or propylene carbonate) having high ionic conductivity and high dielectric constant, which may increase charge/discharge performance of the battery, and a low-viscosity linear carbonate-based compound (e.g., ethylmethyl carbonate, dimethyl carbonate, or diethyl carbonate) may be used.

The lithium salt may be used without particular limitation as long as it is a compound capable of providing lithium ions used in the lithium secondary battery. Specifically, anions of the lithium salt may be at least one selected from the group consisting of F⁻, Cl⁻, Br⁻, I⁻, NO₃⁻, N(CN)₂⁻, BF₄⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻, and as the lithium salt, LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI, LiB(C₂O₄)₂, or the like may be used. It is preferable to use the lithium salt in a concentration range of 0.1 M to 4.0 M, preferably, 0.5 M to 3.0 M, and more preferably, 1.0 M to 2.0 M. When the concentration of the lithium salt is included within the above range, the electrolyte may have suitable conductivity and viscosity, thereby exhibiting excellent performance, and lithium ions may effectively move.

In order to improve life characteristics of the battery, suppress the reduction in battery capacity, and improve discharge capacity of the battery, at least one additive, for example, a halo-alkylene carbonate-based compound such as difluoroethylene carbonate, pyridine, triethylphosphite, triethanolamine, cyclic ether, ethylenediamine, n-glyme, hexaphosphorictriamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxy ethanol, or aluminum trichloride, may be further included in the electrolyte in addition to the electrolyte components. In this case, the additive may be included in an amount of 0.1 wt % to 10.0 wt % based on a total weight of the electrolyte.

As described above, since the lithium secondary battery including the positive electrode active material according to the present disclosure stably exhibits excellent discharge capacity, output characteristics, and capacity retention, the lithium secondary battery is suitable for portable devices, such as mobile phones, notebook computers, and digital cameras, and electric cars such as hybrid electric vehicles (HEVs).

Thus, according to another aspect of the present disclosure, a battery module including the lithium secondary battery as a unit cell and a battery pack including the battery module are provided.

The battery module or the battery pack may be used as a power source of at least one medium and large sized device of a power tool; electric cars including an electric vehicle (EV), a hybrid electric vehicle (HEV), and a plug-in hybrid electric vehicle (PHEV); or a power storage system.

Hereinafter, examples of the present invention will be described in detail in such a manner that it may easily be carried out by a person with ordinary skill in the art to which the present invention pertains. The invention may, however, be embodied in many different forms and should not be construed as being limited to the examples set forth herein.

### EXAMPLES AND COMPARATIVE EXAMPLE

### Example 1

A positive electrode active material precursor, Ni_{0.90}Co_{0.05}Mn_{0.05}(OH)₂, having a D₅₀ of 7.0 μm and a lithium raw material, LiOH, were mixed and then primarily fired at 850° C. for 12 hours.

Thereafter, the primary fired product was pulverized with a jet-mill for 1 hour under the conditions of 2.5 bar and 1, 400 rpm, and then secondarily fired at 750° C. for 12 hours to prepare a positive electrode active material, Ni_{0.90}Co_{0.05}Mn_{0.05}(OH)₂.

### Example 2

A positive electrode active material was prepared in the same manner as in Example 1, except that a positive electrode active material precursor having a D₅₀ of 8.0 μm was used and the jet-mill pulverization was performed for 1 hour under the conditions of 2.5 bar and 1,800 rpm.

### Example 3

A positive electrode active material was prepared in the same manner as in Example 1, except that a positive electrode active material precursor having a D₅₀ of 9.0 μm was used and the jet-mill pulverization was performed for 1 hour under the conditions of 2.5 bar and 2,400 rpm.

### Example 4

A positive electrode active material was prepared in the same manner as in Example 1, except that a positive electrode active material precursor having a D₅₀ of 9.0 μm was used and jet-mill pulverization was performed for 1 hour under the conditions of 3.0 bar and 2,400 rpm.

### Comparative Example 1

A positive electrode active material was prepared in the same manner as in Example 1, except that a positive electrode active material precursor having a D₅₀ of 3.5 μm was used and the jet-mill pulverization was performed for 1 hour under the conditions of 2.5 bar and 800 rpm.

### Comparative Example 2

A positive electrode active material was prepared in the same manner as in Example 1, except that a positive electrode active material precursor having a D₅₀ of 5.5 μm was used and the jet-mill pulverization was performed for 1 hour under the conditions of 2.5 bar and 800 rpm.

### Comparative Example 3

A positive electrode active material was prepared in the same manner as in Example 1, except that a positive electrode active material precursor having a D₅₀ of 7.0 μm was used and the jet-mill pulverization was performed for 1 hour under the conditions of 2.5 bar and 800 rpm.

Comparative Example 4

A positive electrode active material was prepared in the same manner as in Example 1, except that a positive electrode active material precursor having a D50 of 9.0 μm was used and the jet-mill pulverization was performed for 1 hour under the conditions of 2.5 bar and 2,800 rpm.

### Experimental Example 1: Particle Size Distribution of Positive Electrode Active Material

The positive electrode active material (0.005 g) prepared in each of Examples 1 to 4 and Comparative Examples 1 to 4 was dispersed in H₂O as a dispersion medium, and then introduced into a commercially available laser diffraction particle size measuring apparatus (e.g., Microtrac MT 3000), irradiated with an ultrasonic wave of about 28 kHz at a 60-w output to obtain a volume cumulative particle size distribution graph of each positive electrode active material, and D₅₀, D₁₀, Iₘₐₓ and the NSF values of Equation 1 below were calculated using the graph.

$$NSF = ( {D}_{50} - {D}_{10} ) / {I}_{max} \qquad [ Equation 1 ]$$

In Equation 1 above, D₅₀ is a particle diameter at a cumulative volume of 50% in a volume cumulative particle size distribution graph of the positive electrode active material, D₁₀ is a particle diameter at a cumulative volume of 10% in a volume cumulative particle size distribution graph of the positive electrode active material, and Iₘₐₓ is a maximum volume fraction in the volume cumulative particle size distribution graph of the positive electrode active material.

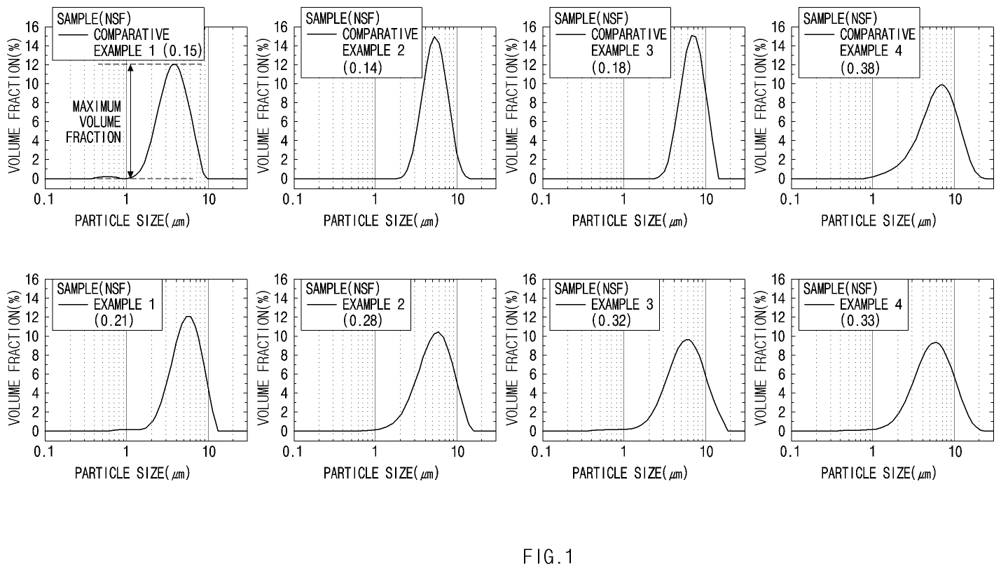

The volume cumulative particle size distribution graphs of the respective positive electrode active materials are shown in FIGS. 1, and D₅₀, D₁₀, Iₘₐₓ, and NSF values of Equation 1 are shown in Table 1 below.

TABLE 1

| | D₅₀ [μm] | D₁₀ [μm] | Iₘₐₓ | NSF |
|---|---|---|---|---|
| Example 1 | 5.62 | 3.10 | 12.00 | 0.21 |
| Example 2 | 5.81 | 2.92 | 10.40 | 0.28 |
| Example 3 | 6.01 | 2.95 | 9.65 | 0.32 |
| Example 4 | 5.90 | 2.82 | 9.35 | 0.33 |
| Comparative | 3.96 | 2.17 | 11.90 | 0.15 |
| Example 1 | | | | |
| Comparative | 5.64 | 3.60 | 14.80 | 0.14 |
| Example 2 | | | | |
| Comparative | 7.41 | 4.79 | 14.50 | 0.18 |
| Example 3 | | | | |
| Comparative | 6.80 | 3.11 | 9.79 | 0.38 |
| Example 4 | | | | |

### Experimental Example 2: Tap Density and Pellet Density of Positive Electrode Active Material

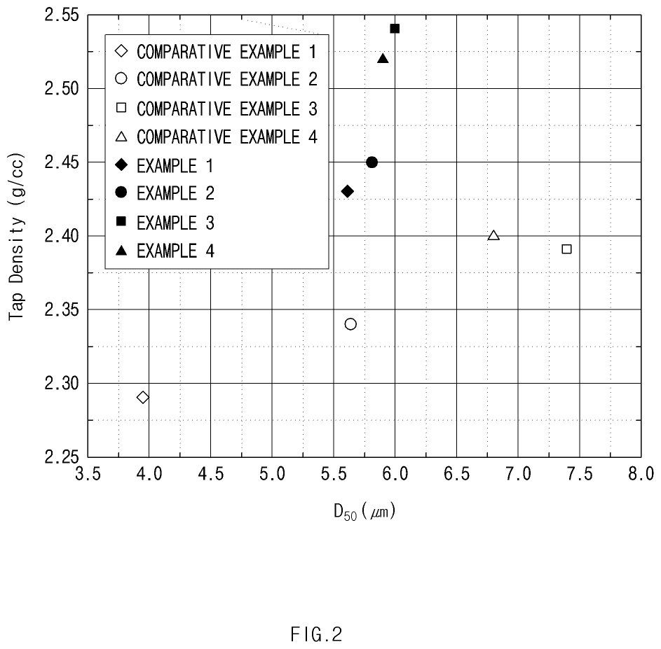

A tap density of the positive electrode active material prepared in each of Examples 1 to 4 and Comparative Examples 1 to 4 was measured using a tap density tester (Micromeritics GeoPyc 1365). Specifically, a 45-cc container was filled with 10 g of the positive electrode active material prepared in each of Examples 1 to 4 and Comparative Examples 1 to 4, and then was vibrated until a force of 108 N was applied horizontally to measure a tap density. The measurement results are shown in Table 2 below, and the tap densities depending on D₅₀ are shown in FIG. 2.

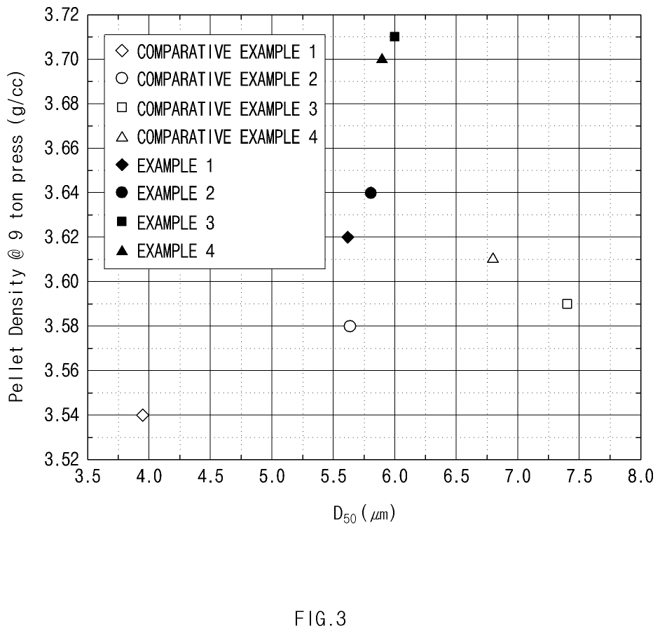

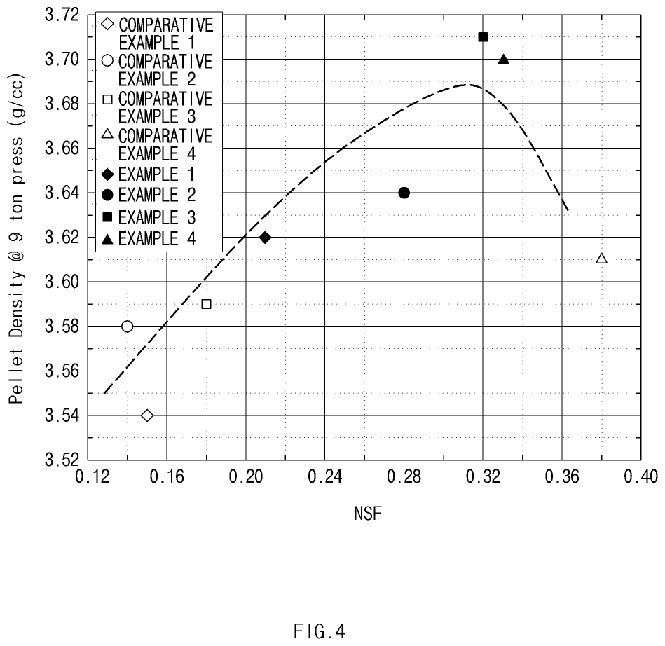

A pellet density of the positive electrode active material prepared in each of Examples 1 to 4 and Comparative Examples 1 to 4 was measured using a density meter (Carver Pellet Press). Specifically, 5 g of the positive electrode active material prepared in each of Examples 1 to 4 and Comparative Examples 1 to 4 was subdivided and filled a cylindrical holder having a diameter of 13 mm without any gaps, and then the pellet density was measured by applying a pressure of 9 ton. The measurement results are shown in Table 2 below, the pellet densities depending on D₅₀ are shown in FIG. 3, and the pellet densities depending on the NSF values are shown in FIG. 4.

TABLE 2

| | | Pellet density |
|---|---|---|
| | Tap density [g/cc] | [g/cc] |
| Example 1 | 2.43 | 3.62 |
| Example 2 | 2.45 | 3.64 |
| Example 3 | 2.54 | 3.71 |
| Example 4 | 2.52 | 3.70 |
| Comparative Example 1 | 2.29 | 3.54 |
| Comparative Example 2 | 2.34 | 3.58 |
| Comparative Example 3 | 2.39 | 3.59 |
| Comparative Example 4 | 2.40 | 3.61 |

Referring to Table 2 above, it was found that the positive electrode active materials of Examples 1 to 4 have higher tap density and higher pellet density than the positive electrode active materials of Comparative Examples 1 to 4. Referring to FIGS. 2 and 3, even when the positive electrode active materials have the same D₅₀ value, it can be seen that when the NSF value satisfies the numerical range according to the examples of the present disclosure, the positive electrode active materials have a high tap density and a high pellet density. In this case, it is believed that the tap density and the pellet density increase as the small particles fill the spaces between the relatively large particles. On the other hand, it is believed that in the case of Comparative Examples 1 to 3 in which the NSF value is less than 0.20, small particles to fill the spaces between large particles are insufficient, and in the case of Comparative Example 4 in which the NSF value is greater than 0.35, small particles remain even after the small particles fill the spaces between the large particles, thereby causing a decrease in the pellet density.

### Experimental Example 3: Initial Resistance of Lithium Secondary Battery

### Manufacture of Lithium Secondary Battery

A positive electrode slurry was prepared by mixing the positive electrode active material prepared in each of Examples 1 to 4 and Comparative Examples 1 to 4, a conductive agent (Carbon black, Denka), and a PVDF binder in a weight ratio of 96:1:3 in N-methylpyrrolidone. The positive electrode slurry was coated on one surface of an aluminum current collector, dried at 130° C., and then rolled to prepare a positive electrode.

A negative electrode active material, a binder, and a conductive agent were mixed in a weight ratio of 97:1.5:1.5 in N-methylpyrrolidone to prepare a negative electrode mixture. Specifically, artificial graphite was used as the negative electrode active material, carboxymethyl cellulose (CMC) was used as the binder, and carbon black was used as the conductive agent. The prepared negative electrode mixture was applied onto one surface of a copper current collector, dried at 110° C., and then rolled to prepare a negative electrode.

An electrode assembly was prepared by interposing a separator between the positive electrode and the negative electrode, and then the electrode assembly was placed inside a battery case, and then an electrolyte solution was injected into the case to manufacture a battery cell. The electrolyte solution was prepared by dissolving 1 M LiPF₆ in a mixed organic solvent in which ethylene carbonate (EC), dimethyl carbonate (DMC), and ethyl methyl carbonate (EMC) was mixed in a volume ratio of 1:1:1, and adding 5 wt % of vinylene carbonate (VC) thereto.

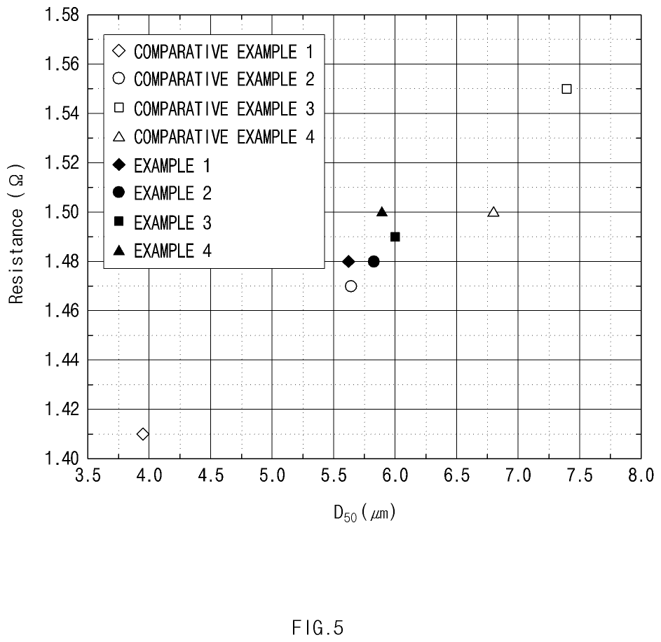

The initial resistance value of the manufactured battery cell was measured through a voltage change when 2.5 C of current was applied at an SOC of 50, at which the battery is half-charged, for 10 seconds. The measurement results are presented in Table 3 and FIG. 5 below:

TABLE 3

| | Initial resistance |
|---|---|
| | (SOC. 50%) |
| Example 1 | 1.48 |
| Example 2 | 1.48 |
| Example 3 | 1.49 |
| Example 4 | 1.49 |
| Comparative Example | 1.41 |
| 1 | |
| Comparative Example | 1.47 |
| 2 | |
| Comparative Example | 1.55 |
| 3 | |
| Comparative Example | 1.50 |
| 4 | |

Referring to Table 3 above and FIG. 5, it was found that the positive electrode active material of Comparative Example 3 having the NSF value of 0.18 and D₅₀ greater than 7.0 μm has a higher initial resistance value than the positive electrode active materials of Examples 1 to 4. It is believed that the diffusion distance of lithium ions in the particles of the positive electrode active material increases, resulting in a decrease in lithium mobility, thereby increasing the initial resistance of the lithium secondary battery including the positive electrode active material. As described above with reference to Experimental Examples 2 to 3, it can be seen that the positive electrode active material of the present disclosure has low initial resistance characteristics while increasing the energy density by maximizing the tap density and the pellet density.

1. A positive electrode active material comprising a single particle composed of one single nodule, a quasi-single particle, which is a composite of at most 30 nodules, or a combination thereof,
wherein:
the positive electrode active material comprises a lithium nickel-based oxide having a molar ratio of Ni of at least 60 mol. % in the total moles of transition metals; and
the positive electrode active material has a negative skewness factor (NSF) of from 0.20 to 0.35, wherein the NSF is calculated according to the following equation:
$$NSF = ( {D}_{50} - {D}_{10} ) / {I}_{max} , \qquad ( 1 )$$
wherein D₅₀ (μm) is a particle diameter at a cumulative volume of 50% in a volume cumulative particle size distribution graph of the positive electrode active material, D₁₀(μm) is a particle diameter at a cumulative volume of 10% in a volume cumulative particle size distribution graph of the positive electrode active material, and Iₘₐₓ(%) is a maximum volume fraction in the volume cumulative particle size distribution graph of the positive electrode active material.

2. The positive electrode active material of claim 1, wherein the positive electrode active material has a D₅₀ of from 5.0 μm to 7.0 μm.

3. The positive electrode active material of claim 1, wherein the lithium nickel-based oxide is represented by the following formula: 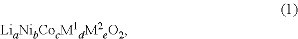
wherein M¹ is Mn, Al, or a combination thereof, M² is at least one selected from the group consisting of Ba, Ca, Zr, Ti, Mg, Ta, Nb, or Mo, 1.0≤a≤1.5, 0.6≤b<1.0, 0<c<0.1, 0<d<0.2, 0≤e≤0.1, and 0<c+d+e<0.4.

4. The positive electrode active material of claim 1, wherein the positive electrode active material has an average particle diameter of nodules of from 1.0 μm to 7.0 μm.

5. The positive electrode active material of claim 1, wherein the positive electrode active material has a tap density (at a force of 108 N applied horizontally) of from 2.40 g/cc to 2.60 g/cc.

6. The positive electrode active material of claim 1, wherein the positive electrode active material has a pellet density (at a pressure of −9 ton) of from 3.60 g/cc to 3.80 g/cc.

7. The positive electrode active material of claim 1, wherein an initial resistance value of a monocell manufactured using the positive electrode active material is from 1.45 Ω to 1.50 Ω, wherein the initial resistance value is measured through a voltage change when 2.5 C of current is applied at an SOC of 50% for 10 seconds.

8. A method for preparing the positive electrode active material according to claim 1, the method comprising:
mixing a positive electrode active material precursor and a lithium raw material and performing primary firing to form a primary fired product; and
pulverizing the primary fired product and performing secondary firing.

9. The method of claim 8, wherein the positive electrode active material precursor has a D₅₀ of from 4.0 μm to 10.0 μm.

10. The method of claim 8, wherein the pulverizing is performed by jet-mill pulverization.

11. The method of claim 10, wherein the jet-mill pulverization is performed under the conditions of from 2.0 bar to 4.0 bar of pressure and a speed range of from 1,000 rpm to 2,500 rpm.

12. A positive electrode comprising the positive electrode active material of claim 1.

13. A lithium secondary battery comprising the positive electrode of claim 12.

14. The lithium secondary battery of claim 13, having an initial resistance value of from 1.45 Ω to 1.50 Ω, wherein the initial resistance value is measured through a voltage change when 2.5 C of current is applied at an SOC of 50% for 10 seconds.

15. The lithium secondary battery of claim 14, wherein the initial resistance value is from 1.47 Ω to 1.50 Ω.

16. The method of claim 11, wherein the positive electrode active material precursor has a D₅₀ of from 4.0 μm to 10.0 μm.

17. The positive electrode active material of claim 1, wherein, the molar ratio of Ni is at least 70 mol. % in the total moles of transition metals.

18. The positive electrode active material of claim 1, wherein, the molar ratio of Ni is at least 80 mol. % in the total moles of transition metals.

19. The method of claim 8, wherein the positive electrode active material precursor has a nickel (Ni) content of at least 60 mol. % in a total metal content.

20. The method of claim 8, wherein the secondary firing is performed for 6 hours to 18 hours at a temperature of from 500° C. to 1,000° C.
